(19) United States
(12) Patent Application Publication
(10) Pub. No.: US 2002/0196152 A1
(43) Pub. Date: Dec. 26, 2002

(54) Automated fire protection system

(76) Inventors: Eric Wilson, Ridgecrest, CA (US); Howard L. Bowman, Ridgecrest, CA (US); Matthew L. Boggs, Ridgecrest, CA (US)

Correspondence Address: NAVAIRWD, COUNSEL GROUP (CODE K0000D), 1 ADMINISTRATION CIRCLE, CHINA LAKE, CA, 93555-6100, US

(21) Appl. No.: 10/175,533

(22) Filed: Jun. 18, 2002

Related U.S. Application Data
(60) Provisional application No. 60/300,414, filed on Jun. 20, 2001.

(51) Int. Cl. G08B 17/00

(52) U.S. Cl. 340/584; 340/539; 169/61; 169/23

(57) ABSTRACT

The disclosed invention relates to a process and system for detecting and extinguishing a spark, flame, or fire on a heat sensitive explosive object, which identifies, locates and relays vital information related to the particular endangered explosive object. The invention protects the sensitive objects, regardless of how they are heated. The invention can be used to protect any heat sensitive object from thermal damage, explosive or not. Thermal energy activates a power supply, which powers the system, including a plurality of status sensor circuits that determine the status of the source of thermal energy. Each source of thermal energy may be individually encoded to relay traits specific to the particular hazardous item, such as cook-off rate, type of energetic material and detonation temperature. Data stored in an EEPROM contains various facts regarding the source of thermal energy. Signals from the plurality of circuits and the EEPROM are relayed to an encoder. Ultimately, all the information from the plurality of circuits and the EEPROM is relayed to personnel via the main system status display board. This allows personnel to become aware of a potential threat and monitor efforts to subdue the threat.

### CROSS REFERENCE TO RELATED APPLICATIONS

This application claims priority under 35 U.S.C. §119(e) of U.S. provisional application No. 60/300,414 filed Jun. 20, 2001.

### STATEMENT REGARDING FEDERALLY SPONSORED RESEARCH OR DEVELOPMENT

The invention described herein may be manufactured and used by or for the government of the United States of America for governmental purposes without the payment of any royalties thereon or therefor.

### BACKGROUND OF THE INVENTION

1. Field of the Invention

The field of the present invention pertains to apparatus and methods for detecting and extinguishing sparks, flames, or fire. More particularly, the invention relates to a process and system for detecting and extinguishing a spark, flame, or fire on a heat sensitive explosive object, which identifies, locates and relays vital information related to the particular endangered explosive object. The invention protects heat sensitive objects, regardless of how they are heated. Throughout the description of the present invention, explosive objects such as bombs and missiles are used to illustrate the use of the invention; however, the invention can be used to protect any heat sensitive object from thermal damage, explosive or not.

2. Description of the Prior Art

To prevent fires, and the resulting loss of life and property, the use of flame detectors or flame detection systems is not only voluntarily adopted in many situations, but is also required by the appropriate authority for implementing the National Fire Protection Association's (NFPA) codes, standards, and regulations. Facilities faced with a constant threat of fire, such as petrochemical facilities and refineries, semiconductor fabrication plants, paint facilities, co-generation plants, aircraft hangers, silane gas storage facilities, gas turbines and power plants, gas compressor stations, munitions plants, airbag manufacturing plants, and so on are examples of environments that typically require constant monitoring and response to fires and potential fire hazard situations.

To convey the significance of the automated fire detection and fire fighting system and process proposed by this patent application, an exemplary environment, in which shipboard ordnance is exposed to the threat or detonation, is explained in some detail. However, it should be understood that the present invention may be practiced in any environment faced with a threat of intense heat or fire.

On Jul. 29, 1967 the Nation's first Super Carrier, the USS Forrestal was conducting combat operations off the coast of North Vietnam in the Tonkin Gulf on Yankee Station. A zuni rocket accidentally fired from a F-4 Phantom on the starboard side of the ship into a parked and armed A-4 Skyhawk. The accidental launch and subsequent impact caused the 400 gallon belly fuel tank and a 1,000 pound bomb on the Skyhawk to fall off, the tank broke open spilling JP5 (jet fuel) onto the flight deck and ignited a fire. Within 90 seconds the bomb was the first to cook-off and explode, this caused a massive chain reaction of explosions that engulfed half the airwings aircraft, and blew huge holes in the 3″ thick steel flight deck. Fed by fuel and bombs from other aircraft that were armed and ready for the coming strike, the fire spread quickly, many pilots and support personnel were trapped and burned alive. Fuel and bombs spilled into the holes in the flight deck igniting fires on decks further into the bowels of the ship. The crew heroically fought the fire and carried armed bombs to the side of the ship to throw them overboard for 13 hours.

Once the fires were under control, the extent of the devastation was apparent. Most tragic was the loss to the crew, 134 had lost their lives, while an additional 64 were injured. With over a dozen major detonations from 1,000 and 500 lb. bombs and numerous missiles, fuel tank, and aircraft the Forrestal and crew suffered injuries, which could have been prevented by the present invention.

A fire on the flightdeck of an aircraft carrier can quickly become catastrophic because of the explosive items located there. The firefighting crew, highly trained an motivated to control and extinguish the conflagration, is quickly eliminated in such a scenario because of their proximity to the detonating weapons that cook-off in the fire. This leaves less experienced, less trained, and less motivated personnel trying to fight an extremely dangerous fire. This scenario is prevented by the present invention. However, it should be noted that a fire is not necessary in order to create a severe fire or explosion hazard in an industrial or military environment. An example of this comes from another Super Carrier tragedy on the USS Enterprise (CVN-65), Jan. 14, 1969. This time, no fire existed prior to the start of weapons cooking-off. Rather, a Zuni rocket, loaded for combat on an F-4 Phantom, was heated until it exploded when the turbine exhaust from an aircraft starter unit (called a “huffer”) was inadvertently positioned to blow directly on the weapons warhead. Subsequently, fire broke out due to damaged fuel tanks leaking fuel onto the deck and igniting. 27 men died in this disaster.

Three primary contributing factors to a fire are: (1) fuel, such as JP5 on the USS Forrestal; (2) heat such as derived from jet exhaust or sympathetic detonation; and (3) oxygen. If the fuel is heated above its ignition temperature (or “flash point”) in the presence of oxygen, then a fire will occur. A fire may self-extinguish if one of the three above mentioned factors is eliminated. Thus, if the fuel supply of the fire is cut off, the fire typically stops. If a fire fails to self-extinguish, current systems incorporate flame detectors which are expected to activate suppression agents to extinguish the fire and thereby prevent major damage. It must be noted that the extinguishment of a fire does not remove the explosion hazard when certain industrial and military chemical compounds (such as explosives and propellants) have been heated by the fire that was extinguished. Under such conditions a phenomena known as thermal runaway can occur and an explosion can happen even after the device (weapon) has been removed from the fire and cooled. Once a complex chemical compound (like explosives or propellants) reaches its point-of-no-return, no amount of cooling can prevent it from cooking-off. In such cases, it is imperative to know the heating history of the compound in order to gauge when it will explode.

Flame detectors, which are an integral part of industrial, must meet standards set by the NFPA, which standards are becoming increasingly stringent. Thus, increased sensitivity, faster reaction times, and fewer false alarms are not only desirable, but are now a requirement. Previous flame detectors have had many drawbacks. The drawbacks of these previous devices have led to false alarms, which unnecessarily stop production or activate fire suppression systems when no fire is present. These prior flame detectors have also failed to detect fires upon occasion, resulting in damage to the facilities in which they have been deployed and/or financial repercussions due to work stoppage or damaged inventory and equipment caused by improper release of the fire suppressant.

One drawback of the most common types of flame detectors is that they can only sense radiant energy in one or more of either the ultraviolet, visible, near band infrared (IR), or carbon dioxide (CO₂) 4.3 micron band spectra. Such flame detectors tend to be unreliable and can fail to distinguish false alarms, including those caused by non-fire radiant energy sources (such as industrial ovens), or controlled fire sources that are not dangerous (such as a lighter). Disrupting an automated process in response to a false alarm can, as noted, have tremendous financial setbacks.

Another drawback of previous fire detectors is their lack of reliability, which can be viewed as largely stemming from their approach to fire detection. The most advanced fire detectors available tend to involve simple microprocessor controls and processing software of roughly the same complexity as those used for controlling microwave ovens. The sensitivity levels of these previous devices are usually calibrated only once, during manufacture. However, the sensitivity levels often change as time passes, causing such conventional flame detectors to fail to detect real fires or to false alarm. In addition, previous fire detectors require a continual source of energy to maintain the fire detection capabilities.

Many of the conventional flame detectors also are limited by their utilization of pyroelectric sensors, which detect only the change in radiant heat emitted from a fire. Such pyroelectric sensors depend upon temperature changes caused by radiant energy fluctuations, and are susceptible to premature aging and degraded sensitivity and stability with the passage of time. In addition, such pyroelectric sensors do not take into account natural temperature variations resulting from environmental temperature changes that occur, typically during the day, as a result of seasonal changes or prevailing climatic conditions.

Other types of conventional flame detectors identify fires by relying primarily on the ability to detect a unique narrow band spectral emissions radiated from hot CO₂ fumes produced by the fire. Hot CO₂ gas from a fire emits a narrow band of radiant energy at a wavelength of approximately 4.3 microns. However, cold CO₂ (a common fire suppression agent) absorbs energy at 4.3 microns, and can therefore absorb a hot CO₂ spike emission generated by a fire. In such situations, conventional CO₂-based flame detectors can miss detecting a fire.

Another type of conventional IR flame detector monitors radiant energy in two infrared frequency bands, typically the 4.3 micron frequency band and the 3.8 micron frequency band, while others use as many as three infrared frequency bands. The dual IR frequency band flame detector commonly utilizes an analog signal subtraction technique for subtracting a reference sensor reading at approximately 3.8 microns from the sensed reading of CO₂ at approximately 4.3 microns. The triple IR frequency band flame detector uses an analogous technique, with an additional reference band at approximately 5 microns. These types of multi-band flame detectors can false alarm when cold CO₂ obscures the fire source from the flame detector, thereby misleading the detector into believing that a strong CO₂ emission spike from a fire is detected, when, in fact, a negative absorption spike (caused by e.g., a CO₂ suppression agent discharge or leak) has been detected.

Conventional flame detectors using ultraviolet (“UV”) sensors also exist, but these too have drawbacks. Also, because arc welding produces copious amounts of intense ultraviolet energy which can be reflected or transmitted over long distances, UV flame detectors can generate false alarms from such UV energy sources, even when the non-fire UV energy is located at a far distance from the spray booth. Moreover, after deployment, conventional UV detectors eventually can become highly de-sensitized as a result of absorbing smoke from a fire and/or solvent mist, causing the UV detector to become blinded. As a result, UV detectors can provide a false sense of security that they are operating at their optimum performance levels, when, in fact, the facility may be vulnerable to a costly fire.

As an additional disadvantage, UV flame detectors generally require a relatively clean viewing window lens for the UV sensor, and can therefore become blinded or degraded by the presence of paint or oil contaminants on the viewing window lens. Moreover, the sensing techniques utilized with conventional UV detectors usually do not take into account the effects of such types of degradation.

Besides problems with flame detection, many or all conventional flame detectors also have limitations or drawbacks relating to their housing and/or mounting that can affect their performance or longevity, in addition to being relatively expensive to manufacture. For example, most optical flame detectors have been built with metal housing made from costly aluminum, stainless steel, or similar materials. Such housings can be heavy, difficult to mount and may not be suitable for certain corrosive environments such as “wet-benches” used in semiconductor fabrication facilities for manufacturing silicon chips and the like.

Further, most or all optical flame detector housings require a window lens (necessary for high optical transmission in the spectral bands used, and typically made of glass, quartz, sapphire, etc.), but it is usually quite difficult to obtain a tight seal of the window lens to metal housings, particularly in chemical manufacturing, or integrated circuit manufacturing or other applications having extremely rigorous environmental requirements. If the flame detector is not tightly sealed, then corrosive chemicals can leak into the electronic circuitry and degrade or destroy the unit.

In flame detectors that detect UV energy, the protective window lens must be constructed from highly expensive quartz, sapphire, or other similar material that does not block UV energy. Moreover, the quartz or sapphire window lenses are typically placed in a metal detector housing, and are collectors of dust and contaminants due to the electrostatic effect of the high voltage field (around 300 to 400 volts) used in the UV detectors. To ensure that the UV detector's sensor(s) can “see through” the window lens, complex and costly “through the lens” tests are necessary. To conduct built-in “through the lens” window lens tests, a UV source tube is generally required to generate a UV test signal. Such UV source tubes require a high voltage for gas discharge sources and/or a large current for incandescent sources. Also, UV source tubes are subject to high failure rates. In sum, these self tests are expensive, require extra power and space, and are prone to breakdowns.

There is a need for a sensitive, reliable, automated, relatively inexpensive, intelligent, and effective method and system for detecting and extinguishing sparks, flames, or fire which limits the life threatening activity of firefighters and prevents tragedies like the one that occurred on the USS Forrestal.

### SUMMARY OF THE INVENTION

There are several objects of the present invention. Overall, it provides the system parts needed to become aware that a fire hazard exists and manages the hazardous situation so that a minimum of damage to property and life occurs.

A preferred embodiment of the present invention discloses a fire detection and response system. First, the fire detection and response system incorporates a means for detecting thermal radiation emitted by a heat source, which also acts as a source of thermal energy. Next, a means for converting the thermal energy from the heat source to electrical energy is connected to a means for storing said electrical energy. The storing means charges to a specified level then initiates a temperature sensor and a transmitter. Then, the transmitter generates a data signal to a means for generating and communicating the data signal according to output from the transmitter.

A means for sensing a location of said heat source detects an omni-directional beacon emitted from the transmitter and produces a location signal and a means for analyzing the location signal triangulates the location of the heat source.

A preferred embodiment of the present invention discloses an apparatus for detecting and responding to a fire. A thermal radiation detector senses thermal radiation emitted by a heat source, which also acts as a source of thermal energy. A power supply subsystem supplies power to the apparatus. In a preferred embodiment, the power supply subsystem comprises a thermal energy to electrical energy converter and a capacitor. A thermal energy to electrical energy converter, such as a thermopile, converts the thermal radiation emitted by the heat source to electrical energy. A thermal energy to electrical energy converter (such as a thermopile, a device that uses the Peltier effect to generate electrical voltage/current from a temperature difference, or an externally-heated-thermal-battery, a device that generates voltage and current by a chemical reaction that takes place at elevated temperatures) converts the thermal radiation emitted by the heat source to electrical energy. The electrical energy is stored in an electrical energy storage device (such as a capacitor) at a specified level then initiates a temperature sensor and a transmitter that generates a data signal. However, a thermal battery may be used as the power supply subsystem. Charging the capacitor is optional for the thermal battery. A data signal generator and communicator receives and interprets the data signal according to output from the transmitter. At least one location sensor detects an omni-directional beacon emitted from said transmitter and produces a location signal and a location signal analyzer triangulates a position of said heat source.

An object of a preferred embodiment of the present invention is to provide an inexpensive, durable heat detector that continuously senses the temperature of the object that the present invention is protecting. This detector is mounted upon or within the object being protected and travels with it at all times. In another embodiment, the detector is removable.

Another object of a preferred embodiment of the present invention is to provide an inexpensive, durable encoder and transmitter that sends the output of the heat detector to an automated, computer-based firefighting control system across the hostile environment presented by burning fuel using electromagnetic waves.

Another object of a preferred embodiment of the present invention is to provide an automated, computer-based firefighting control system that interfaces with all vulnerable objects being protected, firefighting components and human operators, so that the system could run autonomously.

Another object of a preferred embodiment of the invention is to provide a mounted, fixed detector/sensor system that is able to locate the object being protected and determine its temperature, heating rate, composition and serial number using inputs from multiple detectors to triangulate actual explosive location.

A further object of a preferred embodiment of the invention is to provide automated turret-type fire fighting agent applicators and other automated (robotic) firefighting aids that will address the specific concerns and hazards of a given military or industrial environment. These are controlled by the control system to put a cooling stream of water or other agent onto the object of concern, or otherwise eliminate the fire and explosion hazard.

Ordnance-mounted temperature sensor features:

Powered by a thermal energy to electrical energy converter or a thermal battery

Determines current temp and heat up rate

Outputs RF communications signals that may encode:

Weapon

Configuration (mark/mod)

Authentication

Temp of detector

Calculated heat up rate

Calculated total flux absorbed

Fast—acting—fast response at AT

Survives in fuel fire and functions reliably long enough to transmit its information to the sensing and locating system and monitor the thermal response of the item to which it is affixed, preferably up to 30 minutes or more.

Ordnance-mounted power supply features:

Converts thermal energy from fire to electrical energy

Provides stable, metered DC output for electronics

Powers temp sensor electronics and transmitter

Small, light, and pliable (conforms to exterior of object to be protected, i.e. a weapons case)

Powers electronics for up to 30 minutes or more from brief exposure to fire

Ordnance-mounted Communications System features:

Powered by a thermal energy to electrical energy converter or a thermal battery

Transmits data from temp sensor at specified time and/or temperature intervals

Powers transmit antenna

Antenna tuned to operate at elevated temperatures

Transmitter self-tunes output to maximize antenna gain at current antenna temperature

Low power—draws mWs—transmits mW—high efficiency

Survives fuel fire and transmits reliably for >30 minutes through fire

Uses communication method clear of potential interference from fire

Uses communication method clear of other electromagnetic spectrum users

Hazards of electromagnetic radiation to ordnance (HERO)—safe

Sensing and locating system:

Determines transmitting weapon and configuration (mark/mod)

Triangulates exact weapon location

Determines weapons temperature and heat up rate

Calculates time to cook-off

Expandable to control semi-autonomous fire fighting robotics such as automated turrets and/or sacrificial cooler

### BRIEF DESCRIPTION OF THE DRAWINGS

FIG. 1 is an illustration of a preferred embodiment of the present invention, which details the sensor/transmitter system placed on, in or near a potential fire hazard.

FIG. 2 is an illustration of a preferred embodiment of the present invention, which details the triangulation system and the relay of signals to the main system status display board.

FIG. 3 is an illustration of a preferred embodiment of the present invention, which details a fixed sensor and transmitter antenna mounted on ordnance, such as a missile.

FIG. 4 is an illustration of a preferred embodiment of the present invention, which details the coordination of sensors around a potentially hazardous area.

### DETAILED DESCRIPTION

A preferred embodiment of the invention relates to an apparatus and system for detecting and extinguishing a spark, flame, or fire on a heat sensitive explosive that identifies and locates the particular explosive. More particularly, the invention involves a transmitter mounted on a vulnerable object so that the location and temperature of the object may be determined in a fire or other potentially dangerous environment.

A process and system for detecting sparks, flames, or fire in accordance with a preferred embodiment of the present invention is described herein. It should be noted that the term “fire detector” includes other detectors, such as flame detectors and heat detectors, in the present text and refers generally to any process and/or system for detecting sparks, flames, heat or fires, including that produced by explosive type bombs or missiles and other dangerous high-energy phenomena.

A particular embodiment of a process and system for fire detection is described in conjunction with an exemplary situation of the ordnance of a warship. However, it should be understood that the apparatus and system may be effectively utilized in any environment facing a threat from sparks, flames, or fire. For example, the process and system may be used in such applications as petrochemical facilities and refineries, semiconductor fabrication plants, co-generation plants, aircraft hangars, gas storage facilities, gas turbines and power plants, gas compressor stations, munitions plants, airbag manufacturing plants, and other energetics facilities.

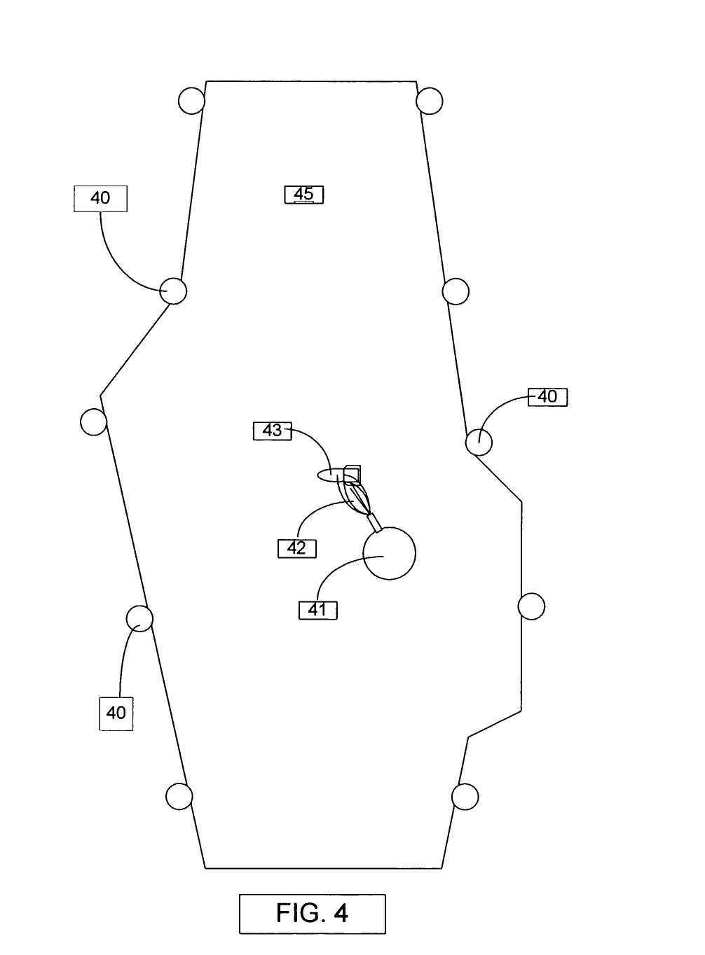

FIG. 4 illustrates an exemplary environment, for example a flight deck of an aircraft carrier 45, where ordnance 43 or other energetic material is exposed the threat detonation. The automated system of a preferred embodiment of the present invention incorporates several parts. An automated, computer-based control system interfaces with all components and human operators, so that the system is capable of running autonomously. Also, the entire automated system could be considered a fire fighting robot. A mounted, fixed detector/sensor system 40 locates ordnance 43 and determine its temperature, heating rate, ordnance type and number control system used inputs from multiple detectors to triangulate actual object location. Automated turret—type fire fighting agent applicators 41 cover the object of concern 43 with water, aqueous film forming foam (AFFF) or any fire fighting foam. These are controlled by a control system 42 to put a cooling stream onto the object of concern 43.

Another preferred embodiment of the present invention incorporates “smart” ordnance. A transmitter could be used to communicate with fixed sensors of the system. The transmitter would be attached to or part of the ordnance. A temperature sensor detects rapid rise in external temperature. In a preferred embodiment of the present invention, the temperature sensor is fabricated using MicroElectroMechanical Systems (MEMS) technology. The rise in external temperature triggers a broadcast mechanism to begin communicating with fixed sensors/automated system. As a result, the ordnance system relays vital information about the endangered ordnance to the fire fighting system. That vital information includes but is not limited to current temperature, the rate of temperature increase or decrease, the likely occurrence of a violent event, such as linear shaped—charge initiation to rupture motor case on AMRAAM, and the likely initiation/detonation of a primary charge. The automated system of a preferred embodiment of the present invention provides advanced warning to a fire fighting personnel that an explosion is likely to occur.

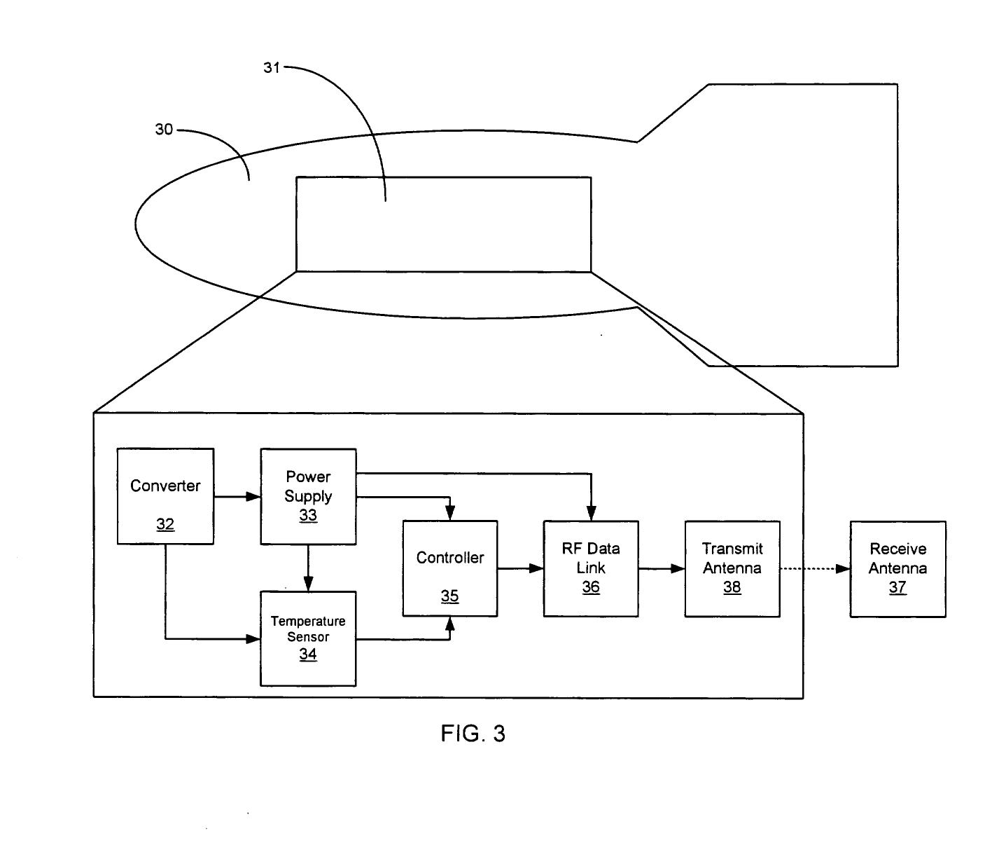

Preferred embodiments of the present invention use either an internal transmitter or an external transmitter. An internal transmitter may be engineered into weapon by design. This could include MEMS temperature sensors in the primary charge/motor/warhead or this could be designed as part of fuse system. Power for the transmitter could come from battery designed into fuse system. An external transmitter would be a system that could be retrofitted onto any object that needs to be monitored. For example, a transmitter may be printed onto mylar to make a very thin device 31 that is pasted onto the outer case of a bomb or missile 30, as illustrated in FIG. 3. Another advantage of the size and position of the mylar transmitter is that it would not change aerodynamic performance of the bomb or missile. In addition to the described benefits relating to shipboard ordnance, this weapons based temperature sensor may be used to alert pilots to any problem with weapons temperature during flight and permit jettison of load before detonation. In a preferred embodiment of the present invention, ordnance is bar coded. The bar code relays information regarding individual characteristics of the endangered ordnance such as energetic material, cook off time and location. However, a bar code can relay any vital information depending upon the monitored environment.

In another preferred embodiment of the present invention, the mylar transmitter is conveniently set at various points in a warehouse or other storage facility where the threat of fire creates a hazard. The system and apparatus of the current invention may be conveniently adapted to use in any building, on a fire truck, and any other area where a fire may occur.

Referring to FIG. 3, to eliminate the need for a continual power supply, the transmitter is powered by a thermal energy to electrical energy converter 32, such as a thermopile, that would generate the power needed for the power supply 33, the temperature sensor 34, controller 35, RF data link 36 and transmit antenna 38. However, a thermal battery may be used as a power supply 33. Thermal radiation from the fire generates the power needed to transmit information from the location of the fire to fire fighting personnel. Thermal radiation from the fire drives the thermal energy to electrical energy converter. Circuitry would be inactive until sufficient heat flux is detected to warrant action so no power source is needed until a hazard exists and the hazard (fire) provides the power to wake up the circuitry and begin communicating with automated fire fighting system.

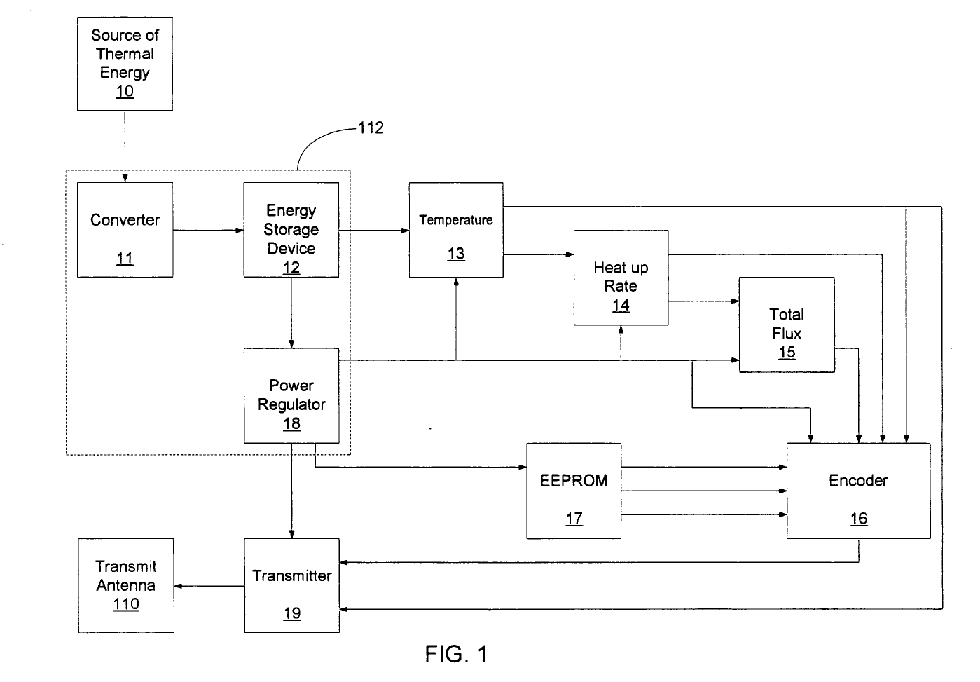

Referring to FIG. 1, the fire fighting system a preferred embodiment of the present invention functions as follows. A casualty occurs causing a fire or other heating of an area. The casualty causes the temperature of a hazardous item, such as ordnance or energetic material, to rise and the hazardous item acts as a source of thermal energy 10. Incoming thermal radiation from the rising temperature is detected by a thermal energy to electric energy converter 111 on the source of thermal energy 10 and broadcast circuitry activates and initiates communication with the automated fire fighting system. Electrical energy from the converter 11 charges an energy storage device 12, such as a capacitor. A thermal battery, depending upon its chemistry, thermal response, and size, may or may not require a capacitor. A thermal battery would replace the thermopile and possibly the energy storage capacitor. The energy storage device 12 creates a signal that goes to a plurality of status sensor circuits 13, 14, and 15. These circuits determine the status of the source of thermal energy 10. In a preferred embodiment, the capacitor signal goes to three circuits to determine temperature 13, heat-up rate 14 and total flux 15. Each source of thermal energy 10 may be individually encoded to relay traits specific to the particular hazardous item, such as cook-off rate and detonation temperature. In a preferred embodiment, the energy storage device 12 is operably coupled to a power regulator. The converter 11, energy storage device 12 and power regulator 18 comprise the power supply system 112. The power regulator 18 is coupled to the temperature circuit 13, heat-up rate circuit 14, total flux circuit 15, encoder 16, erasable programmable read-only memory (EEPROM) 17, and transmitter 19 to provide a stable, regulated DC current. Data stored in the EEPROM 17 contains various facts regarding the source of thermal energy 10, such as weapon type, configuration, location, authentication, energetic material, cook-off temperature and potential danger. Signals from the plurality of circuits 13, 14, and 15 and the EEPROM 17 are relayed to an encoder 16. The encoder 16 takes all the input signals and converts them to digital output for relay to the transmitter 19. Ultimately, all the information from the plurality of circuits 13, 14, and 15 and the EEPROM 17 is relayed to the user via the main system status display board 22. In a preferred embodiment, the temperature circuit 13 is coupled to the transmitter 19 for output control. The transmitter 19 automatically tunes output for the greatest antenna gain at a given temperature. In a preferred embodiment, allow the carrier frequency of the transmitter 19 is varied in relationship to the thermal heating of the transmit antenna 110 to allow the system to operate at peak efficiency. In a another preferred embodiment, the transmit antenna 110 tunes itself into the operating band by designing the transmit antenna 110 to operate at peak efficiency when at the heated temperature, rather than at the normal ambient temperature. The transmitter 19 is operably coupled to a transmit antenna 110. In a preferred embodiment, the transmit antenna 110 is tuned for operation at high temperature. The transmit antenna 110 relays the signal to the receiver and the transmit antenna 110 also provides the omni-directional beacon 25.

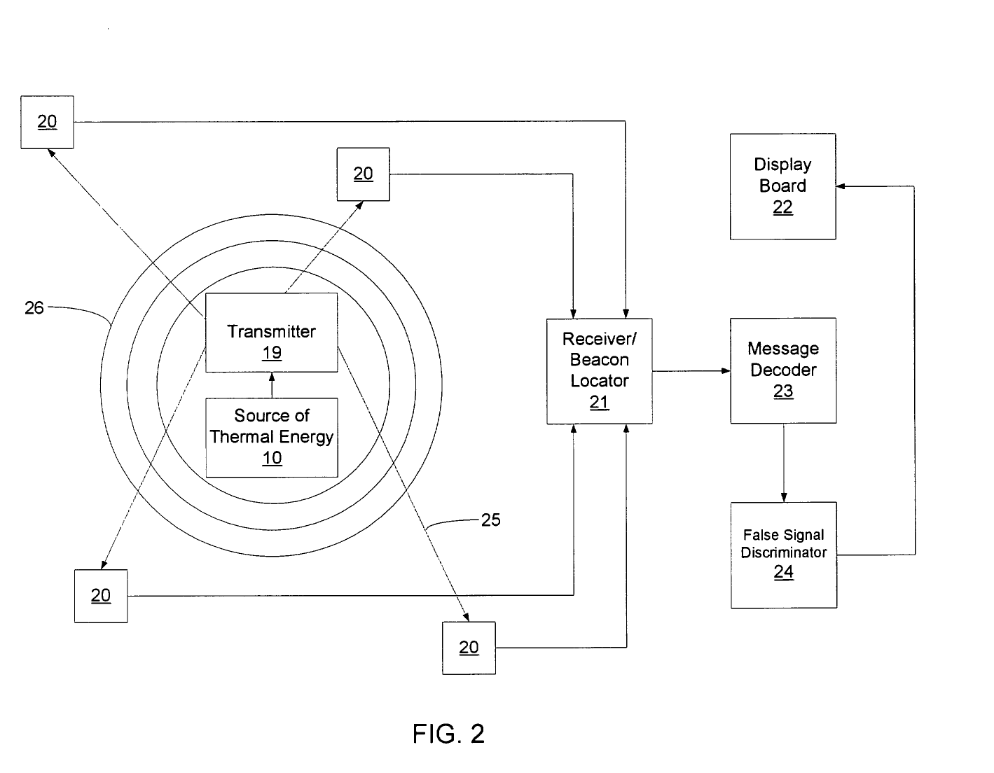

Referring to FIG. 2, fixed sensors 20 detect omni-directional beacons 25 from the transmitter 19 and transmit antenna 110 of the source of thermal energy 10. The automated system of the current invention analyzes signals from fixed sensors 20 and triangulates the actual location of the source of thermal energy 10. Each of the fixed sensors 20 is a receive antenna used to collect the message from the transmitter 19 and transmit antenna 110 and triangulate the exact location of the transmitter 19, which reveals the exact location of the source of thermal energy 10. Each of the fixed sensors 20 transmit a signal to a receiver/beacon locator 21. The message decoder 23 allows the receiver 21 to demodulate the received signal and recover the communications content. The false signal discriminator 24 simply determines the appropriateness of the receiver 21 through use of a unique coding sequence that is subjected to a correlation procedure to determine probability of false detection. The automated system continually monitors the vital information, such as temperature, from fixed sensors. The main system status display board 22 shows temperature, heat-up rate, total flux absorbed, weapon type and configuration, exact antenna location and any other information desired by the user. The display board 22 calculates time to an energetic event and warns of imminent danger. Also, the display board 22 coordinates the automated fire fighting functions.

The automated system sounds an alarm to notify personnel of the hazard and the fire fighting procedures of the automated system deploy. The automated system initiates fire fighting elements, such as fire fighting turrets, that can douse the ordnance location by directing the turrets in the appropriate direction. The fire fighting elements spray cooling water, fire fighting agent or other flame suppressing material onto the ordnance location. In event the weapon broadcast circuitry anticipates a dangerous event such as burning of propellant, shaped-charge breach of weapon case, deflagration or detonation of any charge, the system alerts personnel of impending dangerous event via the display board. The automated system monitors temperature and heat up rate to estimate passing of point of no return for motor or warhead. In the event any detonation or deflagration, an alarm is sounded to allow evacuation of personnel. The automated system of the present invention releases control of all turrets that cannot reach the endangered ordnance location. This allows a human controller to direct fire fighting resources to alternate concerns.

In a preferred embodiment of the present invention, robotic capabilities are added to the automated fire fighting system. After the automated system detects endangered ordnance, a fire fighting robot is initiated. Next, the robot locates the endangered ordnance. In case of ordnance in fire, the robot drives into the fire, locates bomb and delivers a cooling package to cool and thermally protect the ordnance. The robot may find the item autonomously or be instructed by remote systems or both. Hot ordnance must be cooled fast and then thermally protected from further exposure to fire. The robot releases a cooling agent bag onto the ordnance. The cooling agent could be mixture of very cold things or a mix of insulating media in a cold solution. An examples of an applicable cooling agent is a mixture of insulating media and thermally conductive media in liquid nitrogen.

The cooling agent layer closest to the ordnance absorbs heat quickly and the outer layer forms a thermally protective coating. The agent may be comprised of different materials or media whose particle size varies by layer. A thermally conductive layer can “wick” heat away from the bomb and the thermally conductive layer is on the bottom because it would be comprised of very fine material. Similarly, an insulating layer may be made of media of much larger size so that it would “float” on top of the to form insulating protection, but would be removed away from hot item so as not to trap the heat in the ordnance to be cooled. This would occur if the conductive material and the insulating material had roughly the same density or if the conductive material were more dense than the insulating material. Medial separation into conductive and insulating layers would occur in the same manner in which larger stones and/or gravel tend toward the top of a pile (in a shaken coffee can, for instance), and sand and dust tend toward the bottom of the pile (or can). Thermally insulating media might be composed of gravel-sized chunks of material like fast-block or TRV with glass beads in it that would form an increasingly insulating barrier as fire grows hotter. The thermally conductive media may be composed of a metallic sand like Aluminum or Copper. The combination of media carried in a delivery container/bag is combined in a homogeneous mixture carried in liquid nitrogen base.

Although the description above contains many specificities, these should not be construed as limiting the scope of the invention but as merely providing an illustration of the presently preferred embodiment of the invention. Thus the scope of this invention should be determined by the appended claims and their legal equivalents.

What is claimed is:

1. A fire detection and response system, comprising:
means for detecting thermal radiation emitted by a heat source;
means for converting said thermal radiation to electrical energy operably coupled to said means for detecting thermal radiation;
means for storing said electrical energy, wherein said means for storing said electrical energy charges to a specified level then initiates at least one status sensor and a transmitter, wherein said transmitter generates a data signal from said at least one status sensor;
means for generating and communicating said data signal according to output from said transmitter, wherein said means for generating and communicating said data signal receives a signal from said transmitter;
means for sensing a location of said heat source, wherein said sensing means detects an omni-directional beacon emitted from said transmitter and produces a location signal; and
means for analyzing said location signal, wherein analyzing means triangulates said location of said heat source.

2. The fire detection and response system of claim 1, further comprising:
means for cooling said heat source according to output from said means for analyzing said location signal, wherein said cooling means interfaces with said analyzing means.

3. The fire detection and response system of claim 1, further comprising:
means for generating an alarm, wherein said means for alarm generating means interfaces with said transmitter.

4. The fire detection and response system of claim 1, wherein said at least one status sensor comprises:
a temperature sensor, wherein said means for storing said electrical energy charges to a specified level then initiates said temperature sensor;
a heat-up rate sensor, wherein said means for storing said electrical energy charges to a specified level then initiates said heat-up sensor; and
a total flux sensor, wherein said means for storing said electrical energy charges to a specified level then initiates said total flux sensor.

5. The fire detection and response system of claim 1, further comprising:
means for regulating power, wherein said means for regulating power regulates said electrical energy from said means for storing said electrical energy to provide a consistent direct current.

6. The fire detection and response system of claim 1, further comprising:
an erasable programmable read-only memory, wherein said erasable programmable read-only memory stores heat source information.

7. The fire detection and response system of claim 1, further comprising:
an encoder, wherein said encoder converts input from each of said at least one sensor to a digital output and wherein said digital output is sent to said transmitter.

8. The fire detection and response system of claim 6, further comprising:
an encoder, wherein said encoder converts input from each of said at least one sensor and said erasable programmable read-only memory to a digital output and wherein said digital output is sent to said transmitter.

9. The fire detection and response system of claim 1, wherein said means for generating and communicating said data signal is a transmit antenna.

10. The fire detection and response system of claim 1, wherein said means for converting said thermal radiation to electrical energy is a thermopile or a thermal battery.

11. The fire detection and response system of claim 1, wherein said means for storing said electrical energy is a capacitor.

12. The fire detection and response system of claim 2, wherein said means for cooling is at least one turret, wherein said at least one turret sprays said heat source with a cooling agent.

13. The fire detection and response system of claim 12, wherein said cooling agent is selected from the group consisting of foam, water and seawater.

14. An apparatus for detecting and responding to a fire, comprising:
a thermal radiation detector, wherein said thermal radiation detector senses thermal radiation emitted by a heat source;
means for converting said thermal radiation to electrical energy operably coupled to said thermal radiation detector;
a energy storage device, wherein said electrical energy is stored at a specified level then initiates at least one status sensor and a transmitter, wherein said transmitter generates a data signal;
a data signal generator and communicator, wherein said generator and communicator receives and interprets said data signal according to output from said transmitter at least one location sensor, wherein said at least one location sensor detects an omni-directional beacon emitted from said transmitter and produces a location signal; and
a location signal analyzer, wherein location signal analyzer analyzes said location signal and triangulates a position of said heat source.

15. The fire detection and response system of claim 8, further comprising:
at least one turret, wherein said at least one turret sprays cooling agent on said heat source according to output from location signal analyzer.

16. The fire detection and response system of claim 8, further comprising:
an alarm, wherein said alarm interfaces with said transmitter.

17. The fire detection and response system of claim 9, wherein said cooling agent is selected from the group consisting of AFFF, water and seawater.

18. The fire detection and response system of claim 14, wherein said at least one status sensor comprises:
a temperature sensor, wherein said means for storing said electrical energy charges to a specified level then initiates said temperature sensor;
a heat-up rate sensor, wherein said means for storing said electrical energy charges to a specified level then initiates said heat-up sensor; and
a total flux sensor, wherein said means for storing said electrical energy charges to a specified level then initiates said total flux sensor.

19. The fire detection and response system of claim 14, further comprising:
power regulator, wherein said power regulator regulates said electrical energy from said capacitor to provide a consistent direct current.

20. The fire detection and response system of claim 14, further comprising:
an erasable programmable read-only memory, wherein said erasable programmable read-only memory stores heat source information.

21. The fire detection and response system of claim 14, further comprising:
an encoder, wherein said encoder converts input from each of said at least one sensor to a digital output and wherein said digital output is sent to said transmitter.

22. The fire detection and response system of claim 21, further comprising:
an encoder, wherein said encoder converts input from each of said at least one sensor and said erasable programmable read-only memory to a digital output and wherein said digital output is sent to said transmitter.

23. The fire detection and response system of claim 14, wherein said data signal generator and communicator said data signal is a transmit antenna.

24. The fire detection and response system of claim 1, wherein said thermal energy to electrical energy converter is a thermopile.

25. The fire detection and response system of claim 1, further comprising:
an alarm, wherein said alarm interfaces with said transmitter and said alarm is activated upon generation of said data signal.

26. The fire detection and response system of claim 14, further comprising:
a display board, wherein said display board shows status sensor information and heat source information received from said data signal.
